(19) United States
(12) Patent Application Publication
(10) Pub. No.: US 2019/0359032 A1
(43) Pub. Date: Nov. 28, 2019

(54) RADIANT HEATER DEVICE

(71) Applicant: DENSO CORPORATION, Kariya-city (JP)

(72) Inventors: Yasuhiro SAGOU, Kariya-city (JP); Takuya KATAOKA, Kariya-city (JP); Asami OKAMOTO, Kariya-city (JP); Manabu MAEDA, Kariya-city (JP); Koji OTA, Kariya-city (JP); Masayuki AOYAMA, Kariya-city (JP); Kouji KONDOH, Kariya-city (JP); Motoki SHIMIZU, Kariya-city (JP); Yoshihiko SHIRAISHI, Kariya-city (JP); Yoshitarou YAZAKI, Kariya-city (JP); Keita SAITOU, Kariya-city (JP)

(21) Appl. No.: 16/537,646

(22) Filed: Aug. 12, 2019

Related U.S. Application Data
(62) Division of application No. 14/780,369, filed on Sep. 25, 2015.

(30) Foreign Application Priority Data
Mar. 28, 2013 (JP) 2013-069338

(51) Int. Cl. B60H 1/22; F28F 7/00; F24D 19/02; F24C 7/04

(52) U.S. Cl. CPC B60H 1/2215; F24C 7/04; F24D 19/02; F28F 7/00

(57) ABSTRACT

A radiant heater device has an electrode embedded in a substrate part and a plurality of heating parts. The electrodes are formed by material that has low specific resistance. An area occupied by the electrode is restricted. The heating parts are formed by material having high specific resistance in order to generate heat so that radiation is produced. The electrode and the heating part are electrically connected within the substrate part. The plurality of heating parts are arranged in parallel between a pair of electrodes. The electrodes and the heating parts are formed in a film-like shape, and the thermal capacity is reduced. As a result, a temperature of the heating parts rises promptly in response to a turning on of power. In addition, the temperature of the heating parts promptly decreases when an object comes into contact therewith.

### CROSS REFERENCE TO RELATED APPLICATIONS

This application a Divisional Application of U.S. patent application Ser. No. 14/780,369 filed on Sep. 25, 2015 which is a U.S. National Phase Application under 35 U.S.C. 371 of International Application No. PCT/JP2014/001487 filed on Mar. 17, 2014 and published in Japanese as WO 2014/156038 A1 on Oct. 2, 2014 which is based on and claims the benefit of priority from Japanese Patent Application No. 2013-069338 filed on Mar. 28, 2013. The entire disclosures of all of the above applications are incorporated herein by reference.

### TECHNICAL FIELD

Disclosure of inventions relates to a radiant heater device which warms an object by heat radiation.

### BACKGROUND

Patent Literature 1 and Patent Literature 2 disclose radiant heater devices. The apparatuses are disposed in a vehicle compartment to face a passenger.

### CITATION LIST

### Patent Literatures

[Patent Literature 1] JP2012-56531A
[Patent Literature 2] JP2012-228896A

### SUMMARY

Apparatuses are effective as apparatuses which give passenger a warm feeling, in order to assist a heating apparatus for vehicle. However, the radiant heater device still needs further improvements.

It is an object of the present invention to provide a radiant heater device which can produce sufficient radiation heat.

The present invention employs the following technical means, in order to attain the above-mentioned object.

One of the inventions comprises: a substrate part formed by electrical insulation material to provide a surface; a pair of electrodes supported by the substrate part to be extended along the surface; and a plurality of heating parts which are made by material of which specific resistance is higher than that of the pair of electrodes to radiate heat radiation by generating heat in response to power supply, and are supported by the substrate part to be extended along the surface, and are arranged in parallel between the pair of electrodes.

According to this structure, a plurality of heating parts are arranged in parallel between the electrodes. Accordingly, large heat generation can be acquired by supplying power in parallel to the plurality of heating parts. The heating parts are made of material with a specific resistance higher than that of the electrodes. Conversely, the specific resistance of the material of the electrodes is lower than the specific resistance of the material of the heating parts. Although a large current flows into the electrodes by connecting the plurality of heating parts in parallel, heat generation on the electrodes is reduced. In addition, uneven distribution of current to the plurality of heating parts is reduced.

### BRIEF DESCRIPTION OF THE DRAWINGS

FIG. 1 is a cross sectional view of a vehicle showing a radiant heater device according to a first embodiment;

FIG. 2 is a plan view of the radiant heater device according to the first embodiment;

FIG. 3 is a cross sectional view on a line III-III in FIG. 2;

FIG. 4 is a partial cross sectional view showing a thermal conduction model of the radiant heater device;

FIG. 5 is a partial cross sectional view showing a thermal conduction model of the radiant heater device;

FIG. 6 is a graph showing a characteristic between a thermal resistance and a temperature according to the first embodiment;

FIG. 7 is a graph showing a characteristic between a thermal conductive rate and a cross sectional area according to the first embodiment;

FIG. 8 is a waveform chart showing an example of operation according to the first embodiment;

FIG. 9 is a plan view of a radiant heater device according to a second embodiment;

FIG. 10 is a plan view of a radiant heater device according to a third embodiment;

FIG. 11 is a plan view of a radiant heater device according to a fourth embodiment;

FIG. 12 is a cross sectional view on a line XII-XII in FIG. 11;

FIG. 13 is a plan view of a radiant heater device according to a fifth embodiment;

FIG. 14 is a cross sectional view on a line XIV-XIV in FIG. 13;

FIG. 15 is a plan view of a radiant heater device according to a sixth embodiment;

FIG. 16 is a cross sectional view on a line XVI-XVI in FIG. 15;

FIG. 17 is a plan view of a radiant heater device according to a seventh embodiment;

FIG. 18 is a cross sectional view on a line XVIII-XVIII in FIG. 17;

FIG. 19 is a plan view of a radiant heater device according to an eighth embodiment;

FIG. 20 is a cross sectional view on a line XX-XX in FIG. 19;

FIG. 21 is a plan view of a radiant heater device according to a ninth embodiment;

FIG. 22 is a cross sectional view on a line XXII-XXII in FIG. 21;

FIG. 23 is a plan view of a radiant heater device according to a tenth embodiment; and

FIG. 24 is a cross sectional view on a line XXIV-XXIV in FIG. 23.

### DETAILED DESCRIPTION

Embodiments of the present disclosure are explained referring to drawings. In the embodiments, the parts corresponding to the matter described in the previous embodiment are indicated with the same reference numbers and the same descriptions will not be reiterated. In a case that only a part of component is described, the other embodiments previously described may be applied to the other parts of components. In a consecutive embodiment, a correspondence is shown by using a similar reference symbol in which only hundred and more digits differ to indicate a part corresponding to a matter described in the previous embodiment, and the same description may not be repeated. It is possible to combine the embodiments in some forms which are clearly specified in the following description, and also, unless trouble arises, in some forms which are not clearly specified.

### First Embodiment

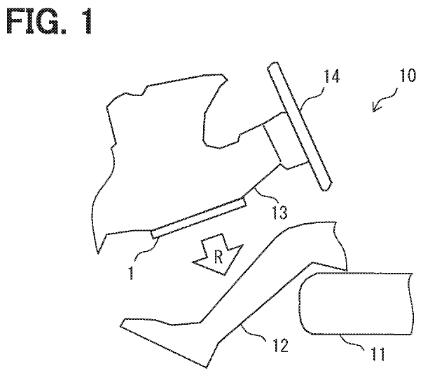

In FIG. 1, the radiant heater device 1 according to a first embodiment is mounted on an interior of a room of movable bodies, such as a road vehicle, a marine vessel, and an aircraft. The device 1 provides a part of a heating apparatus 10 for the interior of the room. The device 1 is an electric heater which generates heat in response to electric power supply from a power source, such as a battery, a generator, etc. which are carried in the movable body. The device 1 is formed in a shape of thin plate. The device 1 generates heat by being supplied with electric power. The device 1 emits a heat radiation R mainly towards a direction vertical to a surface thereof, in order to warm an object body positioned in the direction vertical to the surface.

In the room, a seat 11 for a passenger 12 to sit down is installed. The device 1 is disposed in the room to emit the heat radiation R to feet of the passenger 12. The device 1 can be used as an apparatus for providing warm feeling immediately to the passenger 12 at a stage immediately after starting of the heating apparatus 10. The device 1 is disposed on a wall of the room. The device 1 is disposed so that the device 1 faces the passenger 12 in an assumed usual posture. For example, the road vehicle has a steering column 13 for supporting a handle 14. The device 1 may be disposed on an underside of the steering column 13 to face the passenger 12. The device 1 is disposed so that a front surface is exposed towards an interior of a room. The device 1 is substantially exposed to the room, without having a covering member for preventing that the passenger 12 touches the surface of the device 1 directly.

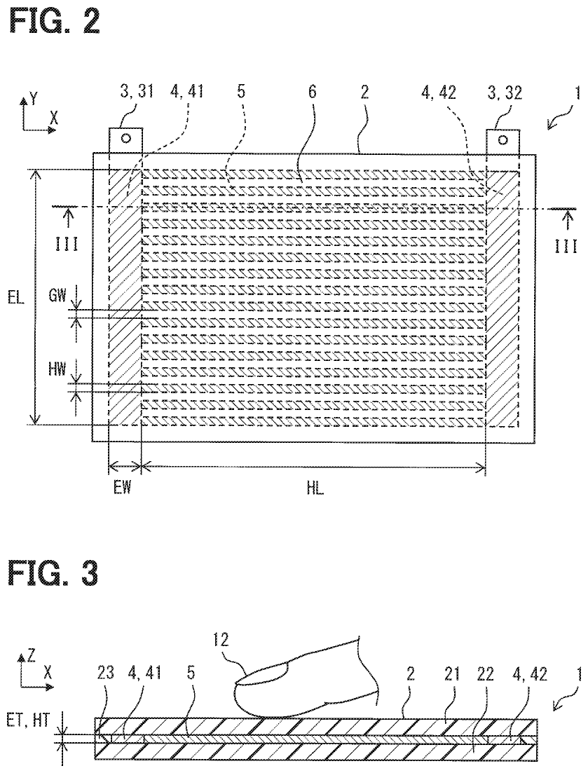

In FIG. 2, the device 1 spreads over an X-Y plan defined by an axis X and an axis Y. The device 1 is formed in a shape of an almost square flat plate. The device 1 has a substrate part 2, a plurality of electrodes 3 and 4, and a plurality of heating parts 5. In the drawing, in order to show the electrodes 3 and 4 embedded within the substrate part 2, and the heating parts 5, hatching is attached.

FIG. 3 shows a cross-section on a line III-III in FIG. 2. In the drawing, the device 1 has a thickness in a direction of an axis Z. The device 1 may also be called a plate shaped heater which emits a heat radiation R mainly towards a direction vertical to the surface.

The substrate part 2 is made of a resin material which provides fine electrical insulation properties and withstands in elevated temperature. The substrate part 2 provides the surface. The substrate part 2 is formed in a shape of a flat plate. The substrate part 2 is given a curved surface corresponding to a surface of an attached wall. The substrate part 2 has the rigidity which can maintain the configuration. The substrate part 2 can have the flexibility for enabling deformation to fit on the surface of the wall. The substrate part 2 may be made with thermoplastic resin. The substrate part 2 is a multilayer substrate.

The substrate part 2 has a surface layer 21, a back layer 22, and a middle layer 23. These layers 21, 22, and 23 are provided with sheets of thermoplastic resin. The surface layer 21 faces toward a radiation direction of the heat radiation R. In other words, in a disposed condition of the device 1, the surface layer 21 provides a surface which is disposed to face a part of the passenger 12 who is an object body for heating. A surface of the surface layer 21 is exposed towards the interior of a room. The back layer 22 provides a back surface of the device 1. The middle layer 23 is disposed between the surface layer 21 and the back layer 22. Material which form the electrodes 3 and 4 and the heating parts 5 are supported on one or more of the above-mentioned layers 21, 22, and 23. The substrate part 2 is a member for supporting the electrodes 3 and 4, and the heating parts 5.

Material which provides the substrate part 2 provides the thermal conductivity lower enough than that of the electrodes 3 and 4 and the heating parts 5. The substrate part 2 provides a heat insulation part which reduces the heat conduction between two adjoining heating parts 5.

The plurality of electrodes 3 and 4 have external electrodes 3 which at least a portion exposes to the exterior of the device 1, and internal electrodes 4 embedded within the substrate part 2. The electrodes 3 include a pair of electrodes 31 and 32 for supplying electric power. The pair of electrodes 31 and 32 provide the terminal of the device 1. These electrodes 3 are arranged on the outer surface of the substrate part 2 including an outer rim portion, a front surface and a back surface of the substrate part 2. Some electrodes 3 are embedded within the substrate part 2, and are electrically connected with the electrodes 4. The electrodes 4 may be exposed on the outer surface of the substrate part 2, and may be used as terminals for supplying electrodes.

The electrodes 4 are embedded within the substrate part 2. The electrodes 4 are also bus-bar parts which distribute electric power to the plurality of heating parts 5 mentioned later. The electrodes 4 are extended from the electrodes 3. The electrodes 4 have an electric resistance value low enough compared with the plurality of heating parts 5. The electric resistance value of the electrodes 4 is set to reduce heat generation on the electrodes 4. The electrodes 4 distribute current evenly to the plurality of heating parts 5. The electrodes 4 have a pair of electrodes 41 and 42 for supplying electric power. The pair of electrodes 41 and 42 are arranged separately with each other on both ends of a unit region of the substrate part 2. The pair of electrodes 41 and 42 are extended along both sides of the unit region of the substrate part 2. A region where the pair of electrodes 41 and 42 are disposed and a region between them define the unit region.

Each of the plurality of heat radiation parts 3 is embedded within the substrate part 2. The heating part 5 is arranged between the surface layer 21 and the back layer 22. Therefore, the heating parts 5 are not exposed to the surface of the substrate part 2. The heating parts 5 are protected by the substrate part 2. The heating parts 5 are arranged between a pair of electrodes 41 and 42. The heating parts 5 are extended as lines between the pair of electrodes 41 and 42. The heating part 5 may be called as a wire-shaped heater. The heating part 5 is arranged in straight as a straight line shape between the pair of electrodes 41 and 42. One end of the heating part 5 is connected to one electrode 41 electrically and mechanically. The other end of the heating part 5 is connected to the other electrode 42 electrically and mechanically.

The heating parts 5 are formed in thin plate shapes parallel to the surface of the substrate part 2. The heating parts 5 can emit the heat radiation R by heat supplied by power supply. The heating parts 5 can emit the heat radiation R which may make the passenger 12, i.e., a person, to feel warmth, when heated to a predetermined radiation temperature Tr. Volume of one of the heating parts 5 is set so that the heating part 5 can reach the temperature at which the heating part 5 can emit the heat radiation R by the thermal energy supplied from the heating parts 5. The volume of the heating part 5 is set so that the temperature of the heating parts 5 may rise quickly with the thermal energy supplied from the heating parts 5. The volume of the heating part 5 is set small so as to produce rapid temperature lowering by heat dissipation to the object which contacts on the surface of the device 1. The thickness of the heating part 5 is set thin in order to maximize area parallel to the surface and to minimize the volume. The area of the heating part 5 is set to an area suitable to emit the heat radiation R. The area of the heating part 3 is set smaller than a part of the object, e.g., the passenger 12, positioned to face the surface of the device 1.

The plurality of heating parts 5 are arranged in parallel each other. The plurality of heating parts 5 are connected in electrically parallel between the pair of electrodes 41 and 42. The plurality of heating parts 5 are arranged to define and form clearances 6 between them.

The plurality of heating parts 5 are arranged in an almost evenly distributed manner with respect to the surface of the substrate part 2. The plurality of heating parts 5 are arranged to be distributed in an almost even density within a region between the pair of electrodes 41 and 42. The plurality of heating parts 5 are arranged dispersedly over almost the entire unit region of the substrate part 2.

Shapes and dimensions which define cross-sectional area with respect to an electric current direction of the electrodes 3 and 4, and material of the electrodes 3 and 4 are selected and set to provide a low electric resistance value. The cross-sectional area and material of electrodes 3 and 4 are set to provide a good electric conductor in order to distribute current evenly to the plurality of heating parts 5. Shapes and dimensions which define cross-sectional area with respect to an electric current direction of the heating parts 5, and material of the heating parts 5 are selected and set to provide a high electric resistance value in order to generate the heat radiation R by supplying power. The material of electrodes 3 and 4 and the material of the heating parts 5 are different materials. The electric specific resistance of the material of the electrodes 3 and 4 is sufficiently lower than the electric specific resistance of the material of the heating parts 5.

The electrode 4 is extended long and narrow and has a longitudinal direction along the axis Y. The heating part 4 has a length EL along the axis Y. The length EL corresponds to the electric current direction within the electrode 4. The electrode 4 has a width EW along the axis X. The width EW is perpendicular to the electric current direction. The electrode 4 has a thickness ET along the axis Z. The thickness ET is smaller than the length EL and the width EW. Therefore, the electrode 4 provides an electric conductor with a ribbon-like shape.

The heating part 5 is extended long and narrow and has a longitudinal direction along the axis X. The heating part 5 has a length HL along the axis X. The length HL corresponds to the electric current direction within the heating part 5. The heating part 5 has a width HW along the axis X. The width HW is perpendicular to the electric current direction. The heating part 5 has a thickness HT along the axis Z. The thickness HT is smaller than the length HL and the width HW. Therefore, the heating part 5 provides an electric conductor with a ribbon-like shape.

The width HW is 300 μm (micrometers). The width HW may be set in a range from 100 micrometers to 3 mm (millimeters). It is desirable that the width HW is set smaller than 1 mm. In addition, it is desirable that the width HW is set smaller than 500 micrometers.

The thickness HT is 30 micrometers. The thickness HT may be set in a range from 10 micrometers to 100 micrometers. It is desirable that the thickness HT is set smaller than the width HW (HW>HT). It is desirable that the thickness HT is set smaller than 1 mm. It is desirable that the thickness HT is set smaller than 100 micrometers.

The width EW is set greater than the width HW in order to reduce the electric resistance value in the electrode 4. In this embodiment, a cross-sectional area of the electrode 4 perpendicular to the electric current direction is larger than a cross-sectional area of the heating parts 5 perpendicular to the electric current direction. The specific resistance of the electrodes 4 smaller than the specific resistance of the heating parts 5 makes it possible to reduce the cross-sectional area of the electrodes 4. For the same purpose, a thickness ET may be set greater than a thickness HT.

The clearance 6 has a width GW. A length of the clearance 6 is the same as the length HL of the heating part 5. The plurality of heating parts 5 and the plurality of clearances 6 are arranged alternately over entire length EL of the electrode 4. The width GW of the clearance 6 may be set equally to the width HW of the heating part 5. Thereby, the plurality of heating parts 5 are arranged in an evenly distributed manner. In addition, the heating parts 5 and the clearances 6 with the small width HW and GW are arranged with high density. As a result, a temperature distribution on the surface of the radiant heater device 1 is reduced. Such high-density arrangement of small heating parts 5 contributes to emit uniform heat radiation R from the surface of the radiant heater device 1.

In this embodiment, the radiant heater device 1 is formed in a thin plate shape. The electrodes 3 and 4 and the heating parts 5 which are embedded within the substrate part 2 are in film-like shapes which spread in parallel with the surface of the substrate part 2. Such film-like electrodes 3 and 4 and the heating parts 5 are advantageous in order to emit heat radiation R over large area.

The heating parts 5 are made by material which generates heat by being supplied electric power. The heating parts 5 demonstrate electric resistance along with the electric current direction so as to generate heat by being supplied power. The heating parts 5 may be made of metal material. The heating parts 5 may be made of tin alloy. The heating parts 5 may be made of alloy containing copper, silver, and tin. In addition, the heating parts 5 may be made of materials for heater wire, such as a stainless alloy, a nickel-chromium alloy or an aluminum alloy.

The electrodes 3 and 4 are made by material having a specific resistance lower than that of the material of the heating parts 5. The electrodes 3 and 4 are made by material that generates less caloric power than that of the heating parts 5 when it is supplied with electric power. The electrodes 3 and 4 are made by material with low specific resistance so that a current can be evenly distributed to the plurality of heating parts 5. The electrodes 3 and 4 may be made of metal material. The electrodes 3 and 4 may be made of tin alloy. The electrodes 3 and 4 may be made of alloy containing copper, silver, and tin. In addition, the electrodes 3 and 4 may be made of materials with good conductivity, such as a copper alloy or an aluminum alloy.

The electrodes 4 and the heating parts 5 are joined electrically. The electrodes 4 and the heating parts 5 are joined by sintering. At least one of the electrodes 4 or the heating parts 5 are provided with an alloy containing tin. In a manufacturing process of the device 1, the material which provides the substrate part 2, the electrodes 4, and the heating parts 5 are heated under pressure. In this manufacturing process, the electrodes 4 and the heating parts 5 are unified by sintering. For example, the electrode 4 can be provided by a copper foil, and the heating part 5 can be provided by a powder layer containing tin and silver. The powder layer can be provided by a paste layer containing tin powder, silver powder, and binder resin. The powder layer is alloyed under heat and provides the heating part 5 which is an alloy unified by sintering. In the process which alloys the powder layer, a solid phase diffusion layer is formed between the powder layer and the copper foil. As a result, the copper foil which provides the electrode 4, and the powder layer which provides the heating part 5 are joined electrically and mechanically by sintering.

Alternatively, the electrode 4 may be provided by a powder layer containing tin and silver, and the heating part 5 may be provided by a thin film of heater wire material. Alternatively, the electrode 4 may be provided by a copper foil, the heating part 5 may be provided by a thin film of heater wire material, and a powder layer containing tin and silver may be disposed between them as a joining member.

The plurality of heating parts 5 form conducting paths connected in parallel between the pair of electrodes 41 and 42. As a predetermined voltage, e.g., DC 12V, is supplied to the electrodes 31 and 32, the plurality of heating parts 5 generate heat by the current flowing through the plurality of heating parts 5. When the plurality of heating parts 5 generate heat, heat radiation R is provided from the surface of the device 1. A temperature of the plurality of the heating parts 5 increases quickly more than a temperature increase of room air resulting from the heating apparatus. As a result, it is possible to give warmth to the passenger 12 by heat radiation R quicker than the heating effect of the heating apparatus.

Volume of the electrodes 4 and the heating parts 5 is set to decrease heat capacity thereof. The heat capacity of the heating part 5 is set so that a temperature of a portion where the object contacts falls in a short period of time after the object contacts on the surface of the radiant heater device 1 at a portion above the heating part 5. The heat capacity of the heating part 5 is set so that a surface temperature of the radiant heater device 1 at the contacting portion falls lower than a predetermined temperature in a short period of time after the object contacts on the surface of the radiant heater device 1. In the preferred embodiment, the heat capacity of the heating part 5 is set, in a case that a finger of human contacts on the surface of the radiant heater device 1, so that the surface temperature of the contacting portion falls lower than 60 OC (Celsius degrees) within 0.32 seconds after the contact.

In the preceding embodiments, the specification of the radiant heater device 1, e.g., the dimension of each part, the performance, and material can be set based on a thermal model. The specification of the radiant heater device 1 is set to realize a necessary thermal-energy supply in condition that no object contacts on the surface of the radiant heater device 1. Furthermore, the specification of the radiant heater device 1 is set so that a surface temperature of the radiant heater device 1, in condition that an object contacts on the surface of the radiant heater device 1, may fall at least to a temperature which does not damage the object. The specification of the radiant heater device 1 is set to satisfy both two above-mentioned cases. For example, a cross-sectional area CA perpendicular to the longitudinal direction of the heating part 5 can be set based on the thermal conduction model.

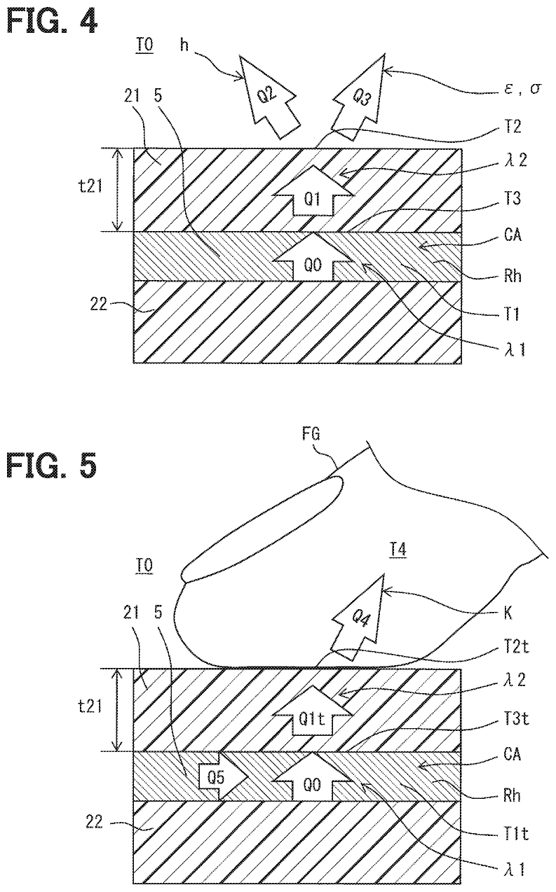

FIG. 4 shows a thermal conduction model in a condition where no object contacts on the radiant heater device 1. In this thermal conduction model, a heat flow which goes to the surface (top face) of the radiant heater device 1 among the thermal energy which the heating parts 5 can generate is shown by modelization.

In the drawing, it is assumed that a heat generation amount of the heating part 5 per unit area on the surface of the radiant heater device 1 is Q0. Q0 may be calculated based on the material of the heating part 5, the dimension of the heating part 5, and the current flowing through the heating part 5. The heating part 5 has a cross-sectional area CA at a cross section which intersects perpendicularly the longitudinal direction. A temperature of the heating part 5 is T1. A temperature of the surface on the surface layer 21 is T2. A thermal conductivity in the heating part 5 is assumed as “λ1 (lambda1)”. A heat transfer coefficient between the heating part 5 and the surface of the surface layer 21 is assumed as “λ2 (lambda2)”. A thickness of the surface layer 21 is t21. A heat transfer amount Q1t (W/m\hat{ }2) (W/square meters) transferred to the surface of the surface layer 21 can be expressed by the following expression (1).

$$\begin{matrix}[ Math 1 ] & \\ Q 1 = \frac{λ2}{t 21} \cdot ( T 1 - T 2 ) & ( 1 )\end{matrix}$$

Heat dissipation from the surface of the radiant heater device 1 is made mainly by the convection and the radiation. A heat transfer coefficient by free convection is assumed as “h”. A temperature of air is T0. The heat dissipation amount Q2 (W/m\hat{ }2) by the convection can be expressed by the following expression (2).

[Math 2]

Q2=h·(T3−T0) (2)

Here, an emissivity from the surface of the radiant heater device 1 is denoted by epsilon (Epsilon), and the Stefan-Boltzmann constant is denoted by sigma (sigma). A heat dissipation amount Q4 by the radiation can be expressed by the following expression (3).

[Math 3]

Q3=ε·σ·(T2⁴−T0⁴) (3)

When the radiant heater device 1 is operated stably by being supplied with the rated power, Q0=Q1=Q2=Q3+Q4 is realized. At this time, the surface temperature T2 is stable at a necessary temperature. A specification of the radiant heater device 1 is set so that the surface temperature T2 reaches to the radiation temperature Tr which can supply a necessary heat radiation R. The radiation temperature Tr is a predetermined temperature not less than 60 OC, for example.

FIG. 5 shows the thermal conduction model in a condition where a second human finger FG contacts the radiant heater device 1. As an object contacts the surface of the radiant heater device 1, the convection and the radiation are impeded at least partially. At least a part of heat dissipation from the surface of the radiant heater device 1 is provided by the heat transfer to the contacting object. Thus, as the object contacts, a thermal balance in the radiant heater device 1 is changed. The temperature of the heating part 5 becomes T1t. The temperature of the surface of the surface layer 21 becomes T2t. The heat transfer amount Q1t transferred to the surface of the surface layer 21 can be expressed by the following expression (4).

$$\begin{matrix}[ Math 4 ] & \\ Q 1 t = \frac{λ2}{t 21} \cdot ( T 1 t - T 2 t ) & ( 4 )\end{matrix}$$

The overall heat transfer coefficient of the contacting body is denoted by K. An internal temperature of contacting object is T4. An amount of heat Q4 dissipated from the surface directly under the contacting object, i.e., an amount of heat Q4 absorbed by the contacting object can be expressed by the following expression (5).

[Math 5]

Q4=K·(T2t−T4) (5)

The surface temperature falls to T2t from T2 as the object contacts thereon. The temperature of the heating part 5 directly under the contacting portion also falls to T1t from T1. Due to a temperature lowering resulting from contact, thermal energy flow in a lateral direction is generated. The heating part 5 is surrounded by the substrate part 2 of which heat transfer coefficient is much lower. Therefore, an amount of heat passing through the heating part 5 becomes dominant in the thermal energy flow in a lateral direction. The thermal resistance in the lateral direction of the heating part 5, i.e., in the longitudinal direction of the heating part 5 is assumed as “Rh”. A temperature of the heating part 5 which is positioned on a surrounding area and has no temperature lowering is assumed as T3t. The heat transfer amount Q5 which passes through in parallel to the surface of the radiant heater device 1, i.e., the heating part 5 in the lateral direction, can be expressed by following expression (6).

$$\begin{matrix}[ Math 6 ] & \\ Q 5 = 2 \times \frac{1}{Rh} \cdot ( T 2 t - T 3 t ) & ( 6 )\end{matrix}$$

A length of the heating part 5 is assumed as HL. The thermal resistance Rh (K/W) about the longitudinal direction of the heating part 5 can be expressed by following expression (7).

$$\begin{matrix}[ Math 7 ] & \\ Rh = \frac{HL}{λ1 \cdot CA} & ( 7 )\end{matrix}$$

When the rated power is supplied to the radiant heater device 1, an object of something may contact a portion of the surface of the radiant heater device 1. In this case, the surface temperature T2 falls due to an amount of heat which the object carries away. Then, a thermal balance is obtained at the contacting portion, Q0+Q5=Q1t=Q4 is realized. At this time, the surface temperature T2t is stable at a temperature lower than the radiation temperature Tr. A specification of the radiant heater device 1 is set so that the surface temperature T2t reaches to a suppressed temperature Tp which is capable of protecting the contacting object. For example, the material defining the thermal resistance Rh and the cross-sectional area Ca may be used as variable factors. The material and the cross-sectional area CA of the heating part 5 are set to make the surface temperature T3 reaches to the suppressed temperature Tp. The suppressed temperature Tp is a predetermined temperature less than 50° C., for example.

In a case that the contacting body has sufficient heat dissipation function, the contacting body can carry away a predetermined amount of heat. For example, in a case that a part of human, e.g., a finger contacts on, heat can be carried away by the blood flow. An amount of heat which the contacting body is capable of carrying away is QH. By realizing Q1t=Q4<QH, the surface temperature T2t converges to a temperature which is higher than a temperature of a part of a human, i.e., a body temperature, but is close to the body temperature. In a case that assuming a part of human contacts on, the suppressed temperature Tp may be set not greater than 40° C.

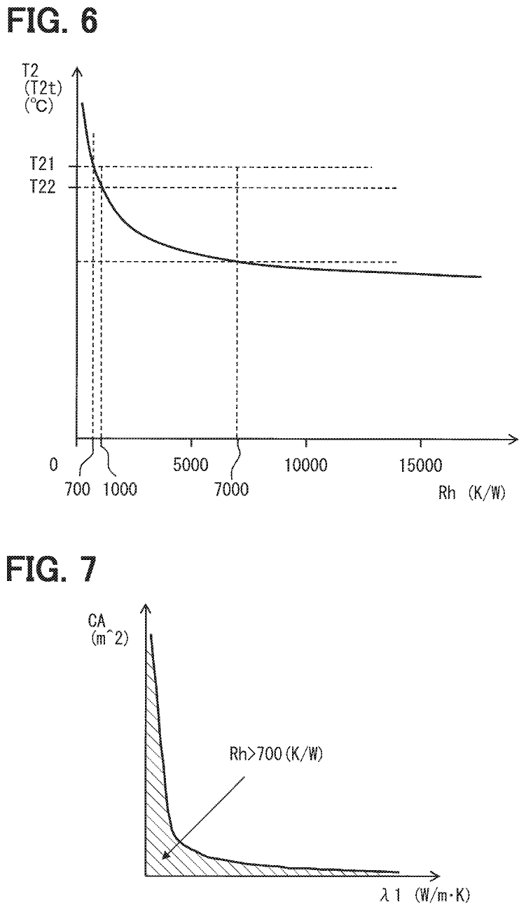

In FIG. 6, a horizontal axis shows the thermal resistance Rh (K/W) in the longitudinal direction of the heating part 5. A vertical axis shows the surface temperature T2 of the radiant heater device 1. The vertical axis also shows the surface temperature T2t in the condition where an object contacts thereon. As illustrated, since the heating part 5 is formed so that the thermal resistance Rh exceeds a predetermined value, the surface temperature T2t is reduced to be less than predetermined temperatures T21 and T22. Here, the thermal resistance Rh can be expressed by following expression (8) by using the length L m (meters) of the heating part, the thermal conductivity λ1 (W/m-K) in the longitudinal direction of the heating part, and the cross-sectional area CA (m\hat{ }2) perpendicular to the longitudinal direction of the heating part.

$$\begin{matrix}[ Math 8 ] & \\ Rh = \frac{L}{λ1 \cdot CA} & ( 8 )\end{matrix}$$

For example, in order to keep it less than the predetermined temperature T21, the thermal resistance Rh can be set to more than 700 (K/W). It is desirable that the thermal resistance Rh is set to more than 1000 (K/W) in order to keep it less than the predetermined temperature T21, The thermal resistance Rh can be set to still higher value, e.g., 7000 (K/W).

The predetermined temperature T21 and T22 can be set so that no trace resulting from a thermal energy is formed on the contacted object. In addition, in a case that a human is assumed as an object that may contacts thereon, the predetermined temperatures T21 and T22 may be set so that the human can allow hotness of the perceived heat, or the human can withstand hotness of the perceived heat.

In FIG. 7, a horizontal axis shows the heat transfer coefficient λ1 (W/m-K) in the longitudinal direction of the heating part 5. A vertical axis shows a cross-sectional area CA (m\hat{ }2) of the heating part. In the drawing, a region (Rh>700 (K/W)) where the thermal resistance Rh exceeds 700 (K/W) is shown by hatching, and a boundary is shown by the solid line. The cross-sectional area CA of the heating part 5 is set to realize a target thermal resistance Rh according to the heat transfer coefficient λ (lambda) of the heating part 5, i.e., the material.

For example, the cross-sectional area CA can be set at a point close to a point 300 micrometers×30 micrometers. In addition, the cross-sectional area CA can be set to be less than 2500 μm\hat{ }2 (square micrometers). In a case that the heating part 5 has a circular cross-sectional area, the diameter thereof can be set less than 500 micrometers.

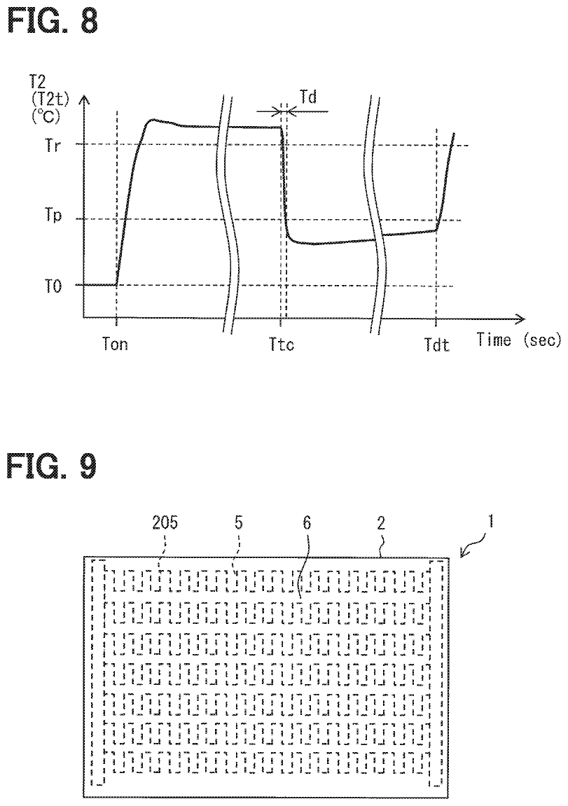

An example of operation of the first embodiment is illustrated in FIG. 8. In time Ton, power supply to the radiant heater device 1 is started. The surface temperature T2 rises rapidly from the room temperature T0 immediately after a start of power supply. The surface temperature T2 reaches promptly the radiation temperature Tr which can emit heat radiation R. A quick starting characteristic is acquired. Temperature rising after a start of power supply is significantly quicker than a rising of air temperature by the heating apparatus. Accordingly, the radiant heater device 1 is effective as a quick heating apparatus.

In time Ttc, the object contacts on the surface of the radiant heater device 1. The contacted object takes a thermal energy from the radiant heater device 1. At this time, in the radiant heater device 1, the substrate part 2, the electrodes 3 and 4, and the heating parts 5 are formed to reduce heat capacities on the unit area thereof. The radiant heater device 1 is formed to reduce the heat transfer in the lateral direction along the surface. In other words, the radiant heater device 1 is given the high thermal resistance Rh in the lateral direction. Specifically, the heating parts 5, which are dominant about the thermal resistance in the lateral direction of the radiant heater device 1, are given the high thermal resistance Rh. It is possible to reduce inflow of the thermal energy from the outer periphery to the part where the object touches.

As shown in the drawing, the surface temperature T2 of the radiant heater device 1 falls rapidly. At this time, the surface temperature T2 falls promptly from the radiation temperature Tr to the suppressed temperature Tp. A period Td in which the surface temperature T2 exceeded the suppressed temperature Tp after the object contacted. Accordingly, even if a human contact, the thermal energy received per unit time is reduced by a level which the humans can permit.

In addition, during the object touches, the surface temperature T2 does not rise rapidly. During the object touches, the surface temperature T2 is maintained by low temperature. The surface temperature T2 may increase gradually. Accordingly, even if human contacts, the human can detach the part which touches, while the thermal energy received per unit time is still within a permissible level.

In time Tdt, the object separates from the surface of the radiant heater device 1. When the object separates, the heat flow from the radiant heater device 1 to the object is lost. Thereby, the surface temperature T2 rises rapidly and exceeds the radiation temperature Tr again.

In this example of operation, forming a trace on the object caused by thermal energy of the radiant heater device 1 is reduced during a period between a time Ttc and a time Tdt. In a case that a part of a human contacts thereon, the human may allow heat perceived, since a period Td where the surface temperature T2 exceeds the suppressed temperature Tp is short.

In this embodiment, the radiant heater device 1 has the substrate part 2 which is formed by electrical insulation material to provide a surface. The radiant heater device 1 has electrodes 4 supported by the substrate part to be extended along the surface, and a plurality of hating parts 5. The pair of electrodes 4, 41, 42 are supported by the substrate part 2 to be extended along the surface. The plurality of heating parts 5 are made by material of which specific resistance is higher than that of the electrodes 4 to radiate heat radiation R by generating heat in response to power supply. The plurality of heating parts 5 are supported by the substrate part 2 to be extended along the surface, and are arranged in parallel between the pair of electrodes 4. According to this structure, the plurality of heating parts 5 are arranged in parallel between the electrodes 4. Accordingly, it is possible to have large generation of heat by parallel power supply to the plurality of heating parts 5. The heating parts 5 are made by material with specific resistance higher than the electrodes 4. Conversely said, the specific resistance of the material of the electrodes 4 is lower than the specific resistance of the material of the heating parts 5. Although large current flows into the electrodes 4 since the plurality of heating parts 5 are connected in parallel, heat generation on the electrodes 4 can be reduced. In addition, uneven distribution of current to the plurality of heating parts 5 may be reduced. The electrodes 4 are formed material of which specific resistance is lower than the heating parts 5. According to this structure, an area occupied with the film-like electrodes 4 on the X-Y plan can be reduced.

The substrate part 2 has the surface layer 21 and the back layer 22. The electrodes 3 and 4 and the heating parts 5 are arranged between the surface layer 21 and the back layer 22. The substrate part 2 is a plate-like shape, and the electrodes 3 and 4 and the heating parts 5 are film-like shapes spreading along the surface. Thermal capacities of both the electrodes 4 and the heating parts 5 are reduced. As a result, a temperature of the heating parts 5 rises promptly in response to a turning on of power. In addition, the temperature of the heating parts 5 promptly decreases when an object comes into contact therewith. The heating part 5 is embedded within the substrate part 2 of which heat transfer coefficient is lower. The substrate part 2 provides a heat insulation part between two adjoining heating parts 5. As a result, even if an object contacts, it is possible to reduce heat transfer from the heating parts 5 that are not located directly below the object. The thermal resistance in the electric current direction, i.e., the longitudinal direction of the heating parts 5 is set significantly higher to enable quick temperature lowering when an object contacts. Thereby, the temperature of the part in contact with an object is reduced.

The heating parts 5 are set to reach a radiation temperature for emitting the heat radiation which makes a human to feel warmth. The heating parts 5 have a thermal resistance Rh in a longitudinal direction which is set, when an object contacts on the surface, a temperature of the part where the object touches falls to a suppressed temperature Tp lower than the radiation temperature Tr. The thermal resistance Rh may be set so that the temperature of the part where an object contacts becomes stable at the suppressed temperature Tp which is lower than the radiation temperature Tr and is slightly higher than a temperature of the object before contact. According to this structure, if an object contacts the surface, the temperature of a contact part will fall to the suppressed temperature Tp from the radiation temperature Tr. It is possible to avoid that the temperature of the portion where the body contacts is maintained at a high temperature over a long period of time. Thereby, a thermal effect on the contacted object is reduced.

The electrodes 4 and the heating parts 5 are joined electrically within the substrate part 2. According to this structure, the electrodes 4 and the heating parts 5 which are made of different material are connected within the substrate part 2. For example, the electrodes 4 and the heating parts 5 are joined by sintering.

The heating part 5 extends in a one-way manner without extending in a reciprocating manner between the pair of electrodes 41 and 42. Thereby, since a length in the electric current direction of the heating parts 5 can be shortened, a large current flows into the heating parts 5 by using low voltage. It is possible to increase heat radiation by the plurality of heating parts 5 connected in parallel.

### Second Embodiment

This embodiment is one of modifications based on a basic form provided by the preceding embodiment. In the preceding embodiment, the heating part 5 extending in a straight line shape is used. Alternatively, in the embodiment illustrated in FIG. 9, heating parts 205 which are arranged in zigzag shapes between the pair of electrodes 41 and 42 are used. The heating part 205 is arranged in a zigzag shape like a square waveform. The shape of the heating part 205 on the X-Y plan may also be called a key-like shape. The heating part 205 can provide long length for conducting current.

### Third Embodiment

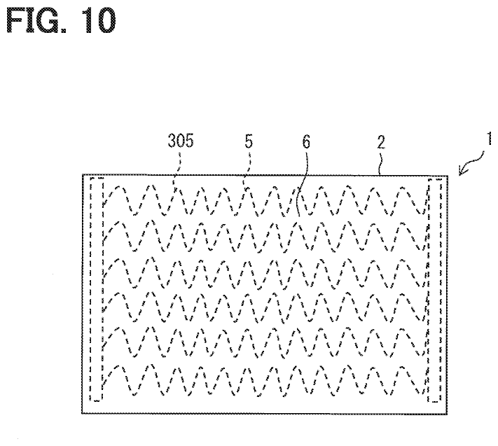

This embodiment is one of modifications based on a basic form provided by the preceding embodiment. In the preceding embodiment, the heating part 5 extending in a straight line shape is used. Alternatively, in the embodiment illustrated in FIG. 10, heating parts 305 which are arranged in zigzag shapes between the pair of electrodes 41 and 42 are used. The heating part 305 is arranged in a zigzag shape like a smooth waveform. The heating part 305 can provide long length for conducting current. In addition, the heating part 305 extends in a smooth waveform, therefore, concentration of electric current can be reduced.

### Fourth Embodiment

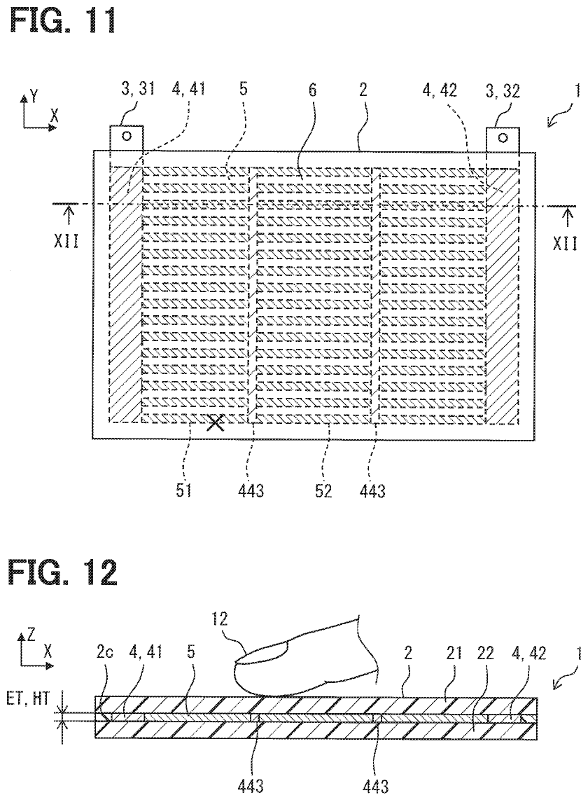

This embodiment is one of modifications based on a basic form provided by the preceding embodiment. In the preceding embodiments, the heating parts 5 extending between the pair of electrodes 41 and 42 are used. In addition, in the embodiment illustrated in FIG. 11 and FIG. 12, a middle electrode 443 is used. The middle electrode 443 electrically connects and short-circuits a plurality of heating parts 5 each other at an intermediate position between the pair of electrodes 41 and 42. The middle electrode 443 short-circuits electrically between at least two adjoining heating parts 5. The middle electrode 443 short-circuits electrically among a plurality of three or more heating parts 5. The middle electrode 443 short-circuits electrically between all the heating parts 5 extended in parallel. In this embodiment, a plurality of middle electrodes 443 and 443 are disposed. The plurality of middle electrodes 443 and 443 are arranged to divide the heating parts 5 into a plurality of parts along the longitudinal direction between the electrodes 41 and 42. The middle electrodes 443 and 443 are arranged to divide the heating parts 5 into half along the longitudinal direction.

The middle electrode 443 provides an alternative current route, when an open circuit occurs at a part of the heating part 5. Accordingly, even if an open circuit occurs at a part of one heating part 5, electric current can be supplied to a remaining portion of the heating part 5. For example, in a case that an open circuit occurs at an X mark in the drawing, a part 51 of the heating part 5 cannot work, but an electric current can be supplied to a part 52 through the middle electrode 443. Thereby, even if a partial open circuit occurs, it is possible to reduce a decrease of usable area.

### Fifth Embodiment

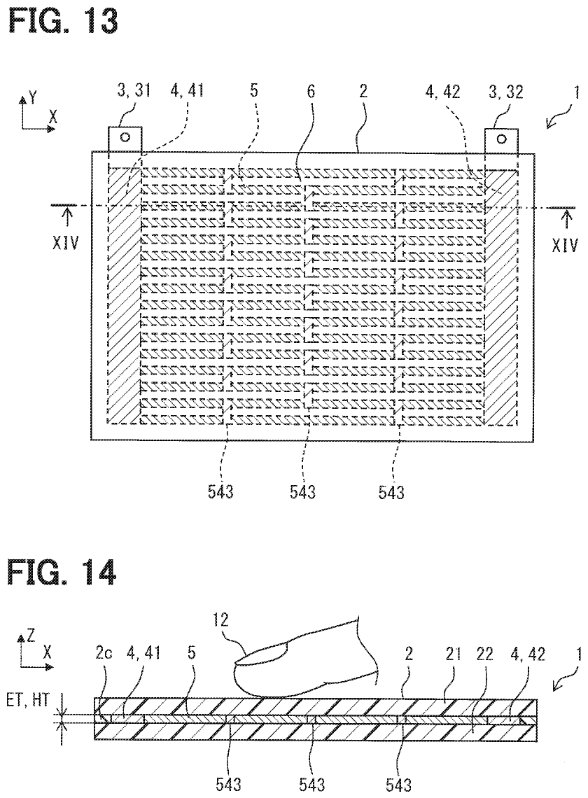

This embodiment is one of modifications based on a basic form provided by the preceding embodiment. In the preceding embodiment, the middle electrode 443 is used. Alternatively, in the embodiment illustrated in FIG. 13 and FIG. 14, a plurality of middle electrodes 543 which electrically connect only two adjoining heating parts 5 are adopted. This embodiment can also reduce a decrease of usable area resulting from a partial open circuit.

### Sixth Embodiment

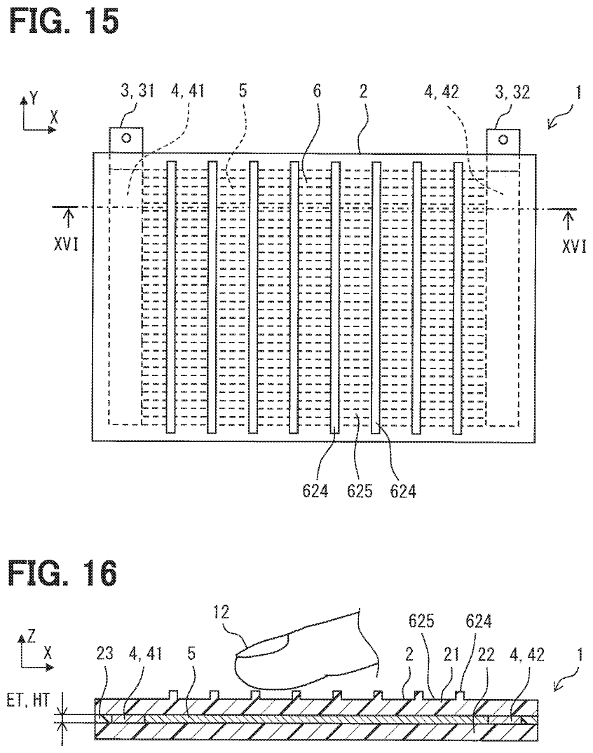

This embodiment is one of modifications based on a basic form provided by the preceding embodiment. In the preceding embodiment, the surface of the surface layer 21 is flat. Alternatively, in the embodiment illustrated in FIG. 15 and FIG. 16, a plurality of dot-like projections 624 are disposed on the surface of the surface layer 21. The projection 624 is a protruded line formed on the surface layer 21. The projection 624 is a narrow protruded line. Therefore, the projection 624 forms a part which is hard to transfer thermal energy from the heating parts 5 on the surface of the surface layer 21. The projection 624 is extended to intersect with the longitudinal direction of the heating parts 5. The projection 624 is extended over the plurality of heating parts 5. The projection 624 is arranged to intersect perpendicularly with all the heating parts 5 arranged in parallel.

The plurality of projections 624 define a plurality of depressions 625 among them. The plurality of projections 624 are arranged in parallel each other. Spacing of the plurality of projections 624 is set less than 5 mm.

According to this structure, the substrate part 2 has the projections 624 which project towards the radiating direction of heat radiation R and the depressions 625 which adjoins the projections 624. The projections 624 are arranged in a distributed manner over a region where the plurality of heating parts 5 are arranged. As a result, the depressions 625 adjoining the projections 624 are also arranged on the surface in a distributed manner.

When an object contacts on the surface of the surface layer 21, the object contacts top surfaces of the projections 624. The projections 624 and the depressions 625 reduce direct contact surface area between the object and the surface layer 21. The projections 624 provide long heat transfer distance. The depressions 625 provide an air layer with high thermal insulation properties. Thereby, it is reduced that a portion of the object approaches to a high temperature portion. As a result, a direct heat transfer from the radiant heater device 1 to the object is reduced.

### Seventh Embodiment

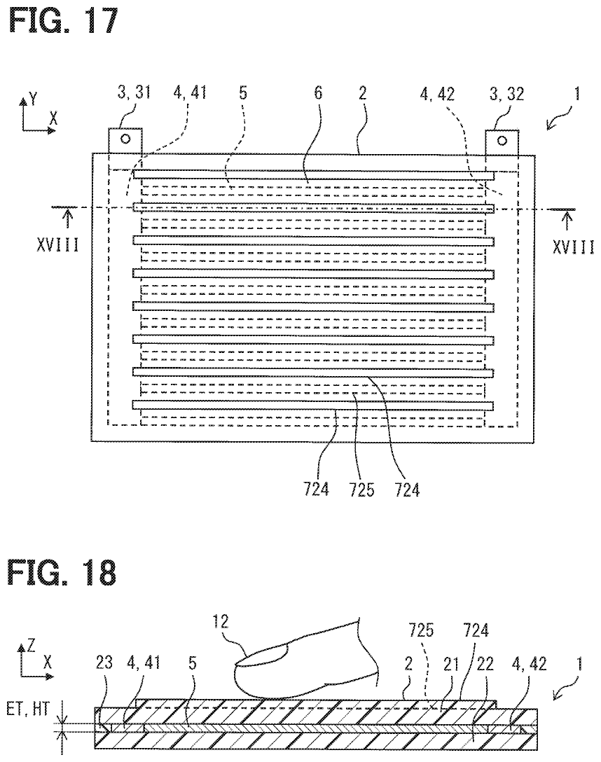

This embodiment is one of modifications based on a basic form provided by the preceding embodiment. In the preceding embodiment, the projections 624 are used. Alternatively, in the embodiment illustrated in FIG. 17 and FIG. 18, projections 724 are used. The surface layer 21 has a plurality of projections 724. The projections 724 are extended in parallel with the heating parts 5. The projections 724 are positioned right above the heating part 5. In other words, the projections 724 are disposed on the heating part 5 in an overlapping manner. The projections 724 define depressions 725 among them. In this configuration, an object would contact on a top surface of the projection 724. As a result, the heat transfer from the radiant heater device 1 to the object is reduced.

### Eighth Embodiment

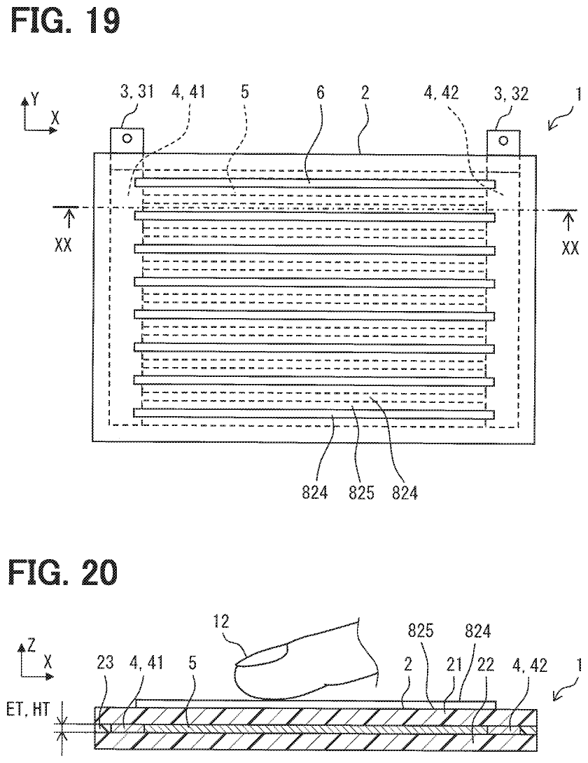

This embodiment is one of modifications based on a basic form provided by the preceding embodiment. In the preceding embodiment, the projections 724 are used. Alternatively, in the embodiment illustrated in FIG. 19 and FIG. 20, projections 824 are used. The surface layer 21 has a plurality of projections 824. The projections 824 are extended in parallel with the heating parts 5. The projections 824 are positioned right above the clearances 6. In other words, the projections 824 are disposed to not overlapping on the heating parts 5. The projections 824 define depressions 825 among them. In this configuration, an object would contact on a top surface of the projection 824. As a result, the heat transfer from the radiant heater device 1 to the object is reduced.

### Ninth Embodiment

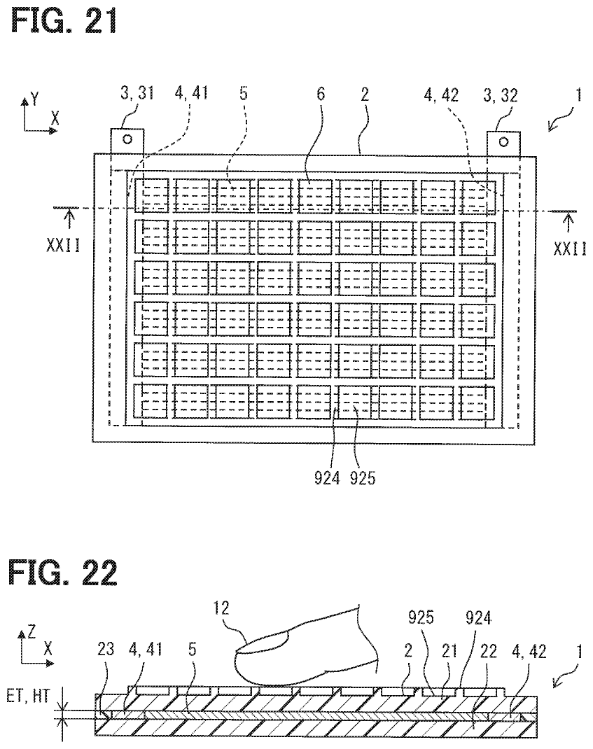

This embodiment is one of modifications based on a basic form provided by the preceding embodiment. In the preceding embodiments, projections extending in parallel are used. Alternatively, in the embodiment illustrated in FIG. 21 and FIG. 22, a projection 924 formed in a grid shape is used. The surface layer 21 has the projection 924 formed in a grid shape including a plurality of protruded lines intersecting each other. The projection 924 has protruded lines extending in parallel with the heating parts 5, and protruded lines extending to intersect with the heating parts 5. In an illustrated example, the plurality of protruded lines intersect at right angles. Some protruded lines are positioned right above the heating parts 5. Some protruded lines are positioned right above the clearances 6. The projection 924 defines depressions 925 among them. The depressions 925 are independent with each other on mesh apertures. In this configuration, an object would contact on a top surface of the projection 924. As a result, the heat transfer from the radiant heater device 1 to the object is reduced.

### Tenth Embodiment

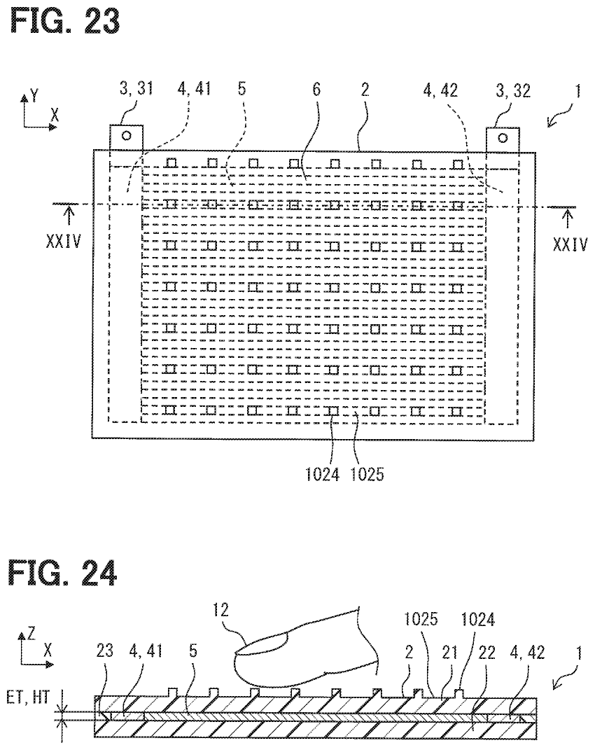

This embodiment is one of modifications based on a basic form provided by the preceding embodiment. In the preceding embodiments, projections extending long and narrow are used. Alternatively, in the embodiment illustrated in FIG. 23 and FIG. 24, a dot-like projection 1024 is used. The surface layer 21 has a plurality of projections 1024. The projection 1024 has a dot-like configuration on the X-Y plan. Some projections 1024 are positioned right above the heating parts 5. Some projections 1024 are positioned right above the clearance 6. The projections 1024 define depressions 1025 among them. Also in this configuration, an object may contact a top surface of the projection 1024. As a result, the heat transfer from the radiant heater device 1 to the object is reduced.

### Other Embodiments

The present disclosure is not limited to the above embodiments, and the present disclosure may be practiced in various modified embodiments. The configuration, function, and advantages of the above described embodiments are just examples. The technical scope of the present disclosure shall not be limited by the above descriptions. The present disclosure is not limited to the above combination, and disclosed technical means can be practiced independently or in various combinations. Some extent of the disclosure may be shown by the scope of claim, and also includes the changes, which is equal to and within the same range of the scope of claim.

In the preceding embodiment, the electrodes 4 and the heating parts 5 are connected by sintering. Alternatively, a connection between the electrodes 4 and the heating parts 5 may be provided by a joined portion using a metal joining material such as soldering, brazing, or welding, or a joined portion using a mechanical joining member such as crimping, or a screw tightening.

In the preceding embodiments, a unit for the radiant heater device 1 is illustrated and explained. A single unit of the radiant heater device 1 may be installed in the room. Alternatively, a plurality of units of the radiant heater device 1 may be arranged to form an array of the radiant heater device.

In the preceding embodiments, projections 624, 724, 824, 924, and 1024 and depressions 625, 725, 825, 925, and 1025 are formed on the surface layer 21. Alternatively, an additional layer that provides projections and depressions may be added on the surface layer 21. In this case, the surface layer is provided by a plurality of layers.

1. A method of radiant heating, the method comprising:
forming a substrate part from an electrical insulating material, the substrate part defining a surface;
supporting a pair of electrodes using the surface of the substrate part, the pair of electrodes extending along the surface of the substrate part;
supporting a plurality of heating parts using the surface of the substrate part, the plurality of heating parts being made by a material which has a specific resistance that is higher than a specific resistance of the pair of electrodes;
electrically connecting the plurality of heating parts to the pair of electrodes;
radiating heat using the plurality of heating parts when the plurality of heating parts are connected to a power supply; wherein
the plurality of heating parts have electric properties which are designed to reach a radiation temperature for emitting the heat radiation; and
the heating parts have a thermal resistance in a longitudinal direction which is designed such that when an object contacts the substrate part, a temperature of the substrate part where the object touches falls to a reduced temperature lower than the radiation temperature.

2. The method of radiant heating claimed in claim 1, wherein a heat capacity of the plurality of heating parts is set such that the temperature of the substrate where the object touches falls below a specified temperature.

3. The method of radiant heating claimed in claim 2, wherein the temperature of the substrate falls below the specified temperature in a predetermined time period.

4. A method of adjusting a temperature of a part of a radiant heater device where an object comes into contact with the radiant heater device, the method comprising:
supplying power from a power source to the radiant heater device, the radiant heater device having a surface and a plurality of heating parts supported by a substrate part formed by an electrical insulation material;
generating heat by the heating parts to reach a radiation temperature for emitting a heat radiation;
contacting the object with the surface of the radiant heater device while supplying power; and
lowering a temperature of the surface from the radiation temperature to a reduced protecting temperature by absorbing heat to the object and by reducing an inflow of thermal energy from the heating parts surrounding the part of the radiant heater to the heating parts surrounded through the plurality of heating parts while supplying power, wherein the inflow of thermal energy flow is defined by a thermal resistance of the heating parts surrounded by the substrate part of which a heat transfer coefficient is much lower than the heating parts.

5. The method claimed in claim 4, wherein
the heating parts are surrounded by the substrate part having the heat transfer coefficient much lower than the heating parts so that the heating parts are dominant in the inflow of thermal energy flow.
